(19) United States
(12) Patent Application Publication
(10) Pub. No.: US 2020/0400591 A1
(43) Pub. Date: Dec. 24, 2020

(54) IMAGE RECONSTRUCTION METHOD AND SYSTEM

(71) Applicant: KROMEK LIMITED, Durham (GB)

(72) Inventor: Angus De Villiers, Sedgefield (GB)

(21) Appl. No.: 16/767,448

(22) PCT Filed: Nov. 29, 2018
(86) PCT No.: PCT/GB2018/053453

§ 371 Date: May 27, 2020

(30) Foreign Application Priority Data
Nov. 30, 2017 (GB) 1719929.0

(51) Int. Cl. G01N 23/10; G01N 23/04; G01N 23/083

(52) U.S. Cl. CPC G01N 23/10; G01N 23/04; G01N 23/083; G01N 2223/3307; G01N 2223/401; G01N 2223/3306; G01N 2223/04

(57) ABSTRACT

A method of construction of a 3-dimensional image from the scanning of an object by penetrating radiation is described comprising: causing an object to pass through a static radiation field; rotating the object as it passes through the static radiation field; thereby successively collecting a plurality of scanned image slices as the object passes through the radiation field; using the image slices to form a 3-dimensional image. A scanning system for construction of a 3-dimensional image from the scanning of an object by penetrating radiation is also described comprising: an object scanner comprising a radiation generator to generate a static imaging radiation field and a radiation detector spaced therefrom to define an imaging zone; an object handler adapted to cause the object to move relative to and pass through the static imaging radiation field and simultaneously rotate the object as it passes through the static imaging radiation field; an image data collector to successively collect scanned image slices as the object passes through the imaging radiation field; an image data processor to process the image slices to form a 3-dimensional image.

The invention relates to a method of a reconstruction of a 3-dimensional image of an item that has been scanned by penetrating radiation such as x-rays. The invention in particular relates to a method of scanning of an object by penetrating radiation such as x-rays that encompasses such image reconstruction. The invention further relates to a system embodying the principles of the methods.

The invention may in particular facilitate the detection of the presence of and/or classification or identification of unexpected or suspicious materials or components within a test object, for example extraneous materials which might represent a threat to security, a breach of customs regulations or the like. The invention in particular relates to security screening and other security, industrial and medical applications where the detection and identification in an image of foreign objects, structures or contents within a larger object is of benefit. However, the invention is not necessarily limited to the investigation of objects inside other objects.

A particular requirement exists to detect explosive materials in portable electronic devices (PEDS). One approach to this issue is the use of Computerised Tomography (CT) systems. Conventional CT scanning for such a security application is discussed by way of example. However, the skilled person will appreciate that CT scanning is widely employed for imaging various objects in wide range of scenarios and will readily be able to apply this discussion of CT scanning, and the consequent discussion of aspects of the invention, across that range of scenarios as applicable.

In CT scanning of portable electronic devices and similar items, the items under test are scanned by penetrating radiation such as x-rays. The use of a CT system allows for a 3-dimensional reconstruction of an item being scanned (voxelated imaging). Each part of the item being scanned can be reconstructed as a three-dimensional pixel (voxel) because of the multiplicity of images/views taken as the generator and detector are rotated around the item being scanned. The multiplicity of views allows for an extremely accurate density measurement to be calculated. This is the operational mode of the currently deployed CT scanners being used for hand and hold baggage screening in airports.

CT imaging can be a powerful tool in security scanning of objects for the detection of suspicious materials structures within and for example for the identification of explosive materials in portable electronic devices. However, the scanning systems required can be complex and the cost of ownership of such systems is high and this may limit deployment in lower volume scenarios such as lower volume passenger throughput airports.

A method and system that enables construction of a 3-dimensional image from the scanning of an object by penetrating radiation such as x-rays that offers the attendant advantages of conventional CT scanning while mitigating in some respects the complexity and cost of existing methods and systems is to be desired.

In accordance with the invention in a first aspect, a method of construction of a 3-dimensional image from the scanning of an object by penetrating radiation such as x-rays comprises:

causing an object to pass through a static imaging radiation field;

rotating the object as it passes through the static imaging radiation field; thereby successively collecting a plurality of scanned image slices as the object passes through the imaging radiation field;

using the image slices to form a 3-dimensional image.

The invention relies on the proposition that to create an image based on a multiplicity of views, it is only necessary to rotate the item being scanned in an imaging field and cross correlate the data to form a voxelated image. The imaging field may be kept static, and in consequence the scanning apparatus simplified.

In a particular embodiment the method comprises:

causing an object to be translated in a longitudinal direction through a two dimensional field of penetrating radiation such as a two dimensional x-ray field;

causing an object to rotate at an axis parallel to the longitudinal direction as it is translated through the two dimensional field of penetrating radiation;

detecting at a suitable detection system the radiation transmitted through the object as it is translated through the two dimensional field of penetrating radiation;

thereby collecting a successive plurality of scanned image slices as the object passes through the imaging radiation field;

using the image slices to construct a 3-dimensional image.

In accordance with the invention in a second aspect, a scanning system for construction of a 3-dimensional image from the scanning of an object by penetrating radiation such as x-rays comprises:

an object scanner for example comprising a radiation generator to generate a static imaging radiation field and a radiation detector spaced therefrom to define an imaging zone;

an object handler adapted to cause the object to move relative to and pass through the static imaging radiation field and simultaneously rotate the object as it passes through the static imaging radiation field;

an image data collector to successively collect scanned image slices as the object passes through the imaging radiation field;

an image data processor to process the image slices to form a 3-dimensional image.

In a particular embodiment a scanning system for construction of a 3-dimensional image from the scanning of an object by penetrating radiation such as x-rays comprises:

an object scanner for example comprising a radiation generator to generate a static two dimensional field of penetrating radiation such as a two dimensional x-ray field;

an object handler adapted to cause an object to be translated in a longitudinal direction through the two dimensional field of penetrating radiation such as the two dimensional x-ray field, and simultaneously to cause an object to rotate about an axis parallel to the longitudinal direction as it is translated through the two dimensional field of penetrating radiation;

a detection system to collect the radiation transmitted through the object as a successive plurality of scanned image slices as the object passes through the imaging radiation field;

an image data collector to successively collect the scanned image slices as the object passes through the imaging radiation field;

an image data processor to process the image slices to form a 3-dimensional image.

The invention relies on the proposition that to create an image based on a multiplicity of views, the item being scanned is rotated in a static imaging field and the successive “image slices” cross correlated to form a voxelated image. The method comprises simultaneously translating the item being scanned through a two dimensional imaging field, for example along a linear translational direction, and rotating the item being scanned, for example about an axis parallel to the linear translational direction. Multiple successive “image slices” may thus be collected at a suitable detector apparatus with a simple static scanning system.

The scanning system for example comprises a radiation generator for generating a two dimensional field of penetrating radiation such as an x-ray source for generating a two dimensional x-ray field, and a radiation detection system such as an x-ray detection system spaced remotely therefrom and positioned to collect the radiation transmitted through an object in the imaging radiation field.

The radiation generator and radiation detection system may be held in fixed spatial relationship to each other and may be statically supported for example on a suitable support body.

The object handler may be mounted in association with the radiation generator and radiation detection system in such configuration that an object handled thereby may be translated and rotated relative to the radiation generator and radiation detection system, and in particular translated through the imaging radiation field and simultaneously rotated. For example, the object handler may be mounted on a suitable support body to be translatable and rotatable relative thereto.

Thus, the invention is distinctly characterised in that the source is fixed in the sense that it produces a static two dimensional field of penetrating radiation such as a two dimensional x-ray field and the detector may be similarly fixed but the object is moved in that it is both translated and rotated through the static radiation field. It will of course be understood that reference herein to a static source/static radiation field is with respect to the frame of reference of the site in which the apparatus is deployed, such as the airport, and of the operator at that site.

In a suitable arrangement the scanning system comprises an L-shaped radiation detector array being a detector array comprising two linear detector arrays at right angles to each other. Such an array for example covers the two tunnel sides of a scanning tunnel of the system. The scanning system preferably further comprises a radiation generator mounted some distance remotely from the array and for example remotely across the scanning tunnel of the system. Such L-shaped radiation detector arrays will be familiar.

Certain system embodiments may have more than one radiation generator and/or more than one radiation detector array.

The object handler is configured to cause the object to move relative to and pass through the static imaging radiation field and simultaneously rotate the object as it passes through the static imaging radiation field. The object handler for example comprises an electromechanical handling arm that rotates the item being scanned around a longitudinal axis whilst passing it through the imaging radiation field.

Preferably the method involves, and the object handler is configured to effect, a matching of the lateral speed to the speed of rotation of the object. For example, the lateral speed to the speed of rotation may be constant, and related to each other by a suitable scaling factor. Matching the lateral speed to the speed of rotation allows for as many views as necessary to be taken, “slice by slice”, as the object to be scanned passes through the beam.

Preferably the method comprises, and the system is configured to effect, collecting data regarding the intensity of transmitted radiation after interaction with an object in the imaging radiation field and the data regarding the intensity of transmitted radiation is processed at the detector system.

The method comprises, and the system is configured to effect, collecting a successive plurality of scanned image slices as the object passes through the imaging radiation field and using the image slices to construct one or more 3-dimensional images of the object as it passes through the imaging radiation field.

For clarification it should be understood that where used herein a reference to the generation of image is a reference to the creation of an information dataset, for example in the form of a suitable stored and manipulatable data file, from which a visual representation of the underlying structure of the object under investigation could be produced. This does not necessarily require the display of a viewable image to a user. It also encompasses the creation of an information dataset or the like of such an image and from which a displayed image could be generated for viewing on a suitable display apparatus.

However, it is not excluded that the invention may form part of a scanning imaging display system. In accordance with this possible embodiment, the dataset(s) of information referred to above may be displayed in a visually accessible form, for example on a suitable display means. The method of the invention conveniently further provides the additional step of displaying such image or images, and in the case of multiple images might involve displaying such images simultaneously or sequentially.

The concept may be deployed with multiple field of view, the so called multi view systems. It can also be deployed with single, dual or multi energy detector arrays.

The concept may be deployed with all existing designs of x-ray scanning system currently approved for use in airports.

As the invention involves movement including rotation of an object under scan through a static imaging field, it is limited for practical purposes to the examination of objects the internal configuration of which is likely to be stable under such rotation, such as for example objects with a rigid internal structure, and may not be practically applicable to loose collections of objects or components such as loose baggage. A particular requirement exists to detect explosive materials in portable electronic devices (PEDS) on entry to a secure space and for example prior to carriage onto an aircraft. PEDS have such rigid structures, and the invention is particularly suited to application in the detection of unauthorised and for example explosive materials within PEDS.

In a possible case, the method is employed as a method of detecting unauthorised and for example explosive materials within portable electronic devices, the system is a scanning system for detecting unauthorised and for example explosive materials within portable electronic devices, in that the method is performed, and the object handler of the system is adapted to hold, an object under test comprising portable electronic device.

The invention will now be described by way of example only with reference to the accompanying drawings in which:

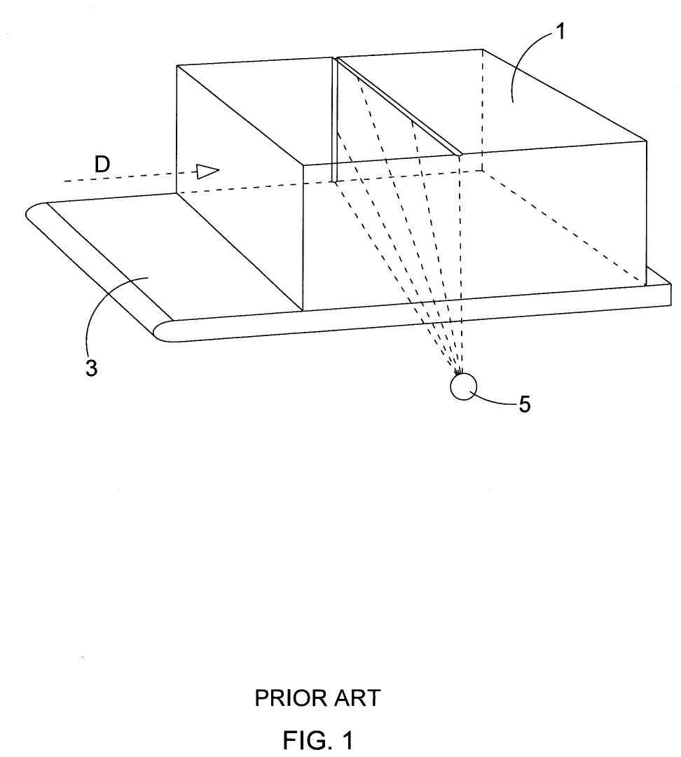

FIG. 1 shows a general layout of a conventional x-ray system, with a single static field of view;

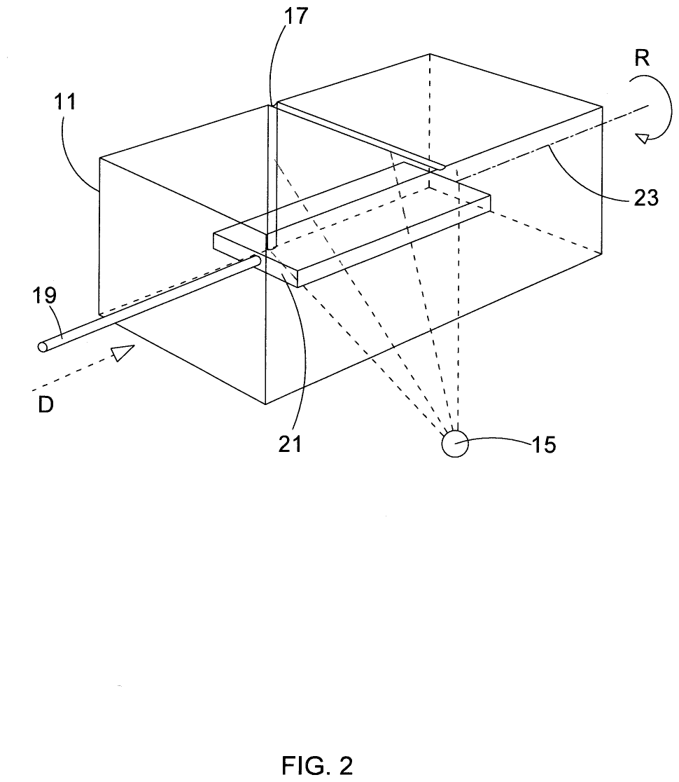

FIG. 2 shows a detector array such as that shown in FIG. 1 adapted to be used as a system and perform a method in accordance with the principles of the invention;

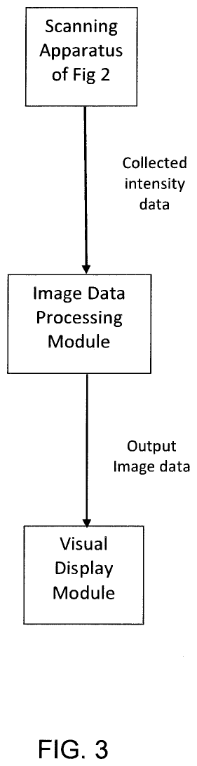

FIG. 3 is a simple flow chart schematic of an arrangement including the detector of FIG. 2 in a more complete system and in performing a method in accordance with the principles of the invention.

The general layout of a conventional x-ray system, with only a single static field of view shown for clarity, is reproduced as FIG. 1. In the example embodiment the system has a rectangular scanning tunnel (1) in which an object under test is scanned. The object under test is caused to move along a linear translational direction (D) by being carried on a belt conveyor (3). The object is therefore caused to pass through a radiation field in a scanning zone (S) of a scanning device within the tunnel (1). Imaging information may be generated as the object under test passes through the radiation field.

The scanning device has a generator comprising an x-ray source (5) mounted some distance from a detector array (7) that covers the two opposing tunnel sides of the system. This is generally known as an L shaped array. Certain system iterations may have more than one generator. Practical systems may have multiple fields of view but only one is shown for clarity.

FIG. 2 shows how that L shaped array may be used with an associated electro-mechanical motion system embodying the principle of the invention that rotates the item being scanned around a longitudinal axis, whilst passing it through the x-ray beam.

As in the example in FIG. 1, a rectangular scanning tunnel (11) is provided in which an object under test is scanned. The scanning device has a generator comprising an x-ray source (15) and an L-shaped detector array (17) that covers the two opposing tunnel sides of the system. A scanning zone is again defined between the x-ray source (15) and an L-shaped detector array (17). The x-ray source and L-shaped detector array are static and define a static radiation field in the scanning zone.

The object under test (21) is caused to move along a linear translational direction (D) by being carried by an electro-mechanical motion system including a handling arm (19). The handling arm causes the object (21) to move along a linear translational direction (D) and thereby pass through the radiation field in the scanning zone.

However, the electro-mechanical motion system is adapted additionally to cause the object under test to rotate about the rotation axis (23) in direction R as it moves laterally through the static imaging radiation field. Matching the lateral speed to the speed of rotation allows for as many views as necessary to be take, slice by slice, as the object to be scanned passes through the beam from the x-ray source.

Multiple views and multiple image slices are thus obtained for further processing in a manner analogous to a conventional CT scanner, but in accordance with the principles of the invention using a static scanning system and in the particular case of the embodiment a single two dimensional static field of view. Multiple image slices from multiple effective views are generated not by movement of the scanning system but by the progressive and simultaneous translation and rotation of the object through this static field of view.

The successive “image slices” may be co-operably processed and cross correlated to form a voxelated image by a suitable image processing method in analogous manner to that used for multiple slices produced by a conventional CT scanner. However, the apparatus required to collect the multiple slices is a simple single view static scanner, and the apparatus and method therefore offer significant advantages of ease of processing and cost of equipment over conventional CT scanners.

An image data processor, which may for example be a processor of a suitably programmed general purpose or special purpose computer may be provided to process the image slices to form a 3-dimensional image. Optional image display means may be provided.

FIG. 3 is a simple flow chart schematic of an arrangement including the detector of FIG. 2 in a more complete system.

An image data processing module receives the collected intensity data “image” slices from the L-shaped detector via a suitable data connection and processes these to create a 3-dimensional image in accordance with the principles of the invention, where the step of creation of a 3-dimensional image will be understood to encompass the creation of an information dataset, for example in the form of a suitable stored and manipulatable data file, from which a visual 3-dimensional representation of the underlying structure of the object under investigation could be produced but not to require that image information dataset to be presented as a viewable or viewed visible image as such.

This image information dataset may then optionally be output via a further suitable data connection to the visual display module which includes a display screen on which it produces such a viewable visible image.

1. A method of construction of a 3-dimensional image from the scanning of an object by penetrating radiation comprising:
causing an object to pass through a static radiation field;
rotating the object as it passes through the static radiation field;
thereby successively collecting a plurality of scanned image slices as the object passes through the radiation field; and
using the image slices to form a 3-dimensional image.

2. A method in accordance with claim 1 comprising:
causing an object to be translated in a longitudinal direction through a two dimensional field of penetrating radiation;
causing an object to rotate at an axis parallel to the longitudinal direction as it is translated through the two dimensional field of penetrating radiation;
detecting at a suitable detection system the radiation transmitted through the object as it is translated through the two dimensional field of penetrating radiation;
thereby collecting a successive plurality of scanned image slices as the object passes through the imaging radiation field; and
using the image slices to construct a 3-dimensional image.

3. A method in accordance with claim 1 wherein the penetrating radiation is x-ray radiation.

4. A scanning system for construction of a 3-dimensional image from the scanning of an object by penetrating radiation comprising:
an object scanner comprising a radiation generator to generate a static imaging radiation field and a radiation detector spaced therefrom to define an imaging zone;
an object handler adapted to cause the object to move relative to and pass through the static imaging radiation field and simultaneously rotate the object as it passes through the static imaging radiation field;
an image data collector to successively collect scanned image slices as the object passes through the imaging radiation field; and
an image data processor to process the image slices to form a 3-dimensional image.

5. A scanning system in accordance with claim 4 wherein:
the object scanner comprises a radiation generator that generates a static two dimensional field of penetrating radiation;
the object handler that causes an object to be translated in a longitudinal direction through the two dimensional field of penetrating radiation, and simultaneously causes an object to rotate about an axis parallel to the longitudinal direction as it is translated through the two dimensional field of penetrating radiation.

6. A scanning system in accordance with claim 4 wherein the radiation generator is a source of x-rays and the radiation detector is a detector of x-rays.

7. A scanning system in accordance with claim 4 comprising a radiation generator for generating a two dimensional field of penetrating radiation, and a radiation detection system comprising at least one radiation detector spaced remotely therefrom and positioned to collect the radiation transmitted through an object in the imaging radiation field.

8. A scanning system in accordance with claim 7 wherein the radiation generator and radiation detection system are held in fixed spatial relationship to each other and may be statically supported for example on a suitable support body.

9. A scanning system in accordance with claim 4 wherein the object handler is mounted in association with the radiation generator and radiation detection system in such configuration that an object handled thereby may be translated and rotated relative to the radiation generator and radiation detection system, and in particular translated through the imaging radiation field and simultaneously rotated.

10. A method in accordance with claim 1 wherein the detector comprises an L-shaped radiation detector array.

11. A method in accordance with claim 1 comprising matching the lateral speed to the speed of rotation of the object.

12. A method in accordance with claim 1 comprising collecting data regarding the intensity of transmitted radiation after interaction with an object in the imaging radiation field and the data regarding the intensity of transmitted radiation is processed at the detector.

13. A method in accordance with claim 1 a scanning system comprises collecting a successive plurality of scanned image slices as the object passes through the imaging radiation field and the image slices are used to construct one or more 3-dimensional images of the object as it passes through the imaging radiation field.

14. A method in accordance with claim 13 further comprising the additional step of displaying such image or images.

15. A method in accordance with claim 1 employed as a method of detecting unauthorised materials within portable electronic devices.
